(19) United States
(12) Patent Application Publication
(10) Pub. No.: US 2025/0042346 A1
(43) Pub. Date: Feb. 6, 2025

(54) MOTOR VEHICLE INTERIOR TRIM PART

(71) Applicant: Novem Car Interior Design GmbH, Vorbach (DE)

(72) Inventors: Tobias Neuner, Buttenheim (DE); Philipp Weih, Haag (DE); Alexander Martin, Neuhaus an der Pegnitz (DE); Ilka Rötzer, Kastl (DE)

(21) Appl. No.: 18/771,745

(22) Filed: Jul. 12, 2024

(30) Foreign Application Priority Data
Jul. 12, 2023 (DE) 102023118484.9

(51) Int. Cl. B60R 13/02; B60Q 3/54

(52) U.S. Cl. CPC B60R 13/02; B60Q 3/54; B60R 2013/0287

(57) ABSTRACT

The invention relates to a motor vehicle interior trim part, wherein the motor vehicle interior trim part has a layered structure, wherein the layered structure comprises a decorative layer with a front side designed as a visible side and a rear side opposite the front side. The invention is characterized in that the motor vehicle trim part has at least one shape-memory material.

### CROSS-REFERENCE TO RELATED APPLICATIONS

The present invention claims priority to German Application 10 2023 118 484.9, filed on Jul. 12, 2023. The entire content of each of the aforementioned patent applications is incorporated herein by reference.

### BACKGROUND OF THE INVENTION

### 1. Field of the Invention

The invention relates to a motor vehicle interior trim part.

### 2. The Relevant Technology

Motor vehicle interior trim parts are understood to mean in particular decorative parts (also: ornamental parts) and/or trim parts for a vehicle interior. Numerous motor vehicle interior trim parts are installed in the vehicle interior, such as door panels, console and instrument panels, and center console panels. The motor vehicle interior trim parts also include control buttons or their covers.

With such motor vehicle interior trim parts, there is often a need for functional integration—for example, a lighting function, a heating function, an acoustic function, or even a (haptic) feedback function in the case of integrated switches.

### BRIEF SUMMARY OF THE INVENTION

The invention is based upon the object of specifying a new motor vehicle interior trim part, in particular a new motor vehicle interior trim part in which functional integration can be realized with minimal use of material.

This object is achieved by a motor vehicle interior trim part having the features of claim 1. Advantageous embodiments and further developments are provided in each of the dependent claims.

The motor vehicle interior trim part according to the invention has a layered structure, wherein the layered structure comprises a decorative layer with a front side designed as a visible side and a rear side opposite the front side.

The invention is characterized in that the motor vehicle interior trim part has at least one shape-memory material, in particular for functional implementation.

The advantages of the invention therefore lie in particular in the fact that the use of shape-memory materials enables functions in the component with relatively little use of material. In addition, this requires only a small amount of installation space.

Furthermore, shape-memory materials can be used to enable haptic effects, in particular by expanding the shape-memory material, which effects provide a feedback function for a user, so that, for example, the driver receives haptic feedback when operating functional elements, e.g., in the area of the center console, the steering wheel, the instrument panel, the backrest, the headrest, or the door panel, and can prevent the driver from averting his gaze from the traffic situation.

The decorative layer is or comprises preferably a wood veneer and/or a plastic, e.g., a film, and/or stone and/or glass and/or fabric and/or material and/or a soft-touch material and/or metal, in particular aluminum, and/or carbon. The decorative layer can also be transparent or translucent.

It can be provided that the decorative layer itself be or comprise the shape-memory material, at least in portions, in particular if the decorative layer is or comprises a metal.

The motor vehicle interior trim part can be a single-component part—for example, made of aluminum. In this case, the decorative layer itself is preferably the shape-memory material, at least in portions.

According to a further development of the invention, the shape-memory material is introduced into the decorative layer and/or applied to the decorative layer—for example, to the rear side of the decorative layer.

It can be provided that the shape-memory material form a symbol in or on the decorative layer, in particular in a plan view of the visible side of the motor vehicle interior trim part, preferably in the activated state. When viewed from above on the visible side of the decorative layer, the symbol may be one or more functional symbols and/or geometries and/or shapes and/or emblems and/or one or more letters and/or lettering and/or characters and/or logos and/or lines, in particular shape-following lines, and/or other design elements.

Preferably, the layer structure comprises a carrier layer arranged on the rear side of the decorative layer—for example, made of plastic or NFPP or natural fiber injection-molding material or a biological material.

The wording “on the rear side of the decorative layer” does not necessarily mean that the carrier layer must be arranged directly and/or immediately on the rear side of the decorative layer. The carrier layer is to be arranged only on the side opposite the front side, designed as the visible side, of the decorative layer. Further layers, in particular intermediate layers, can also be arranged between the decorative layer and the carrier layer, so that the carrier layer is arranged indirectly on the rear side of the decorative layer.

It can be provided that the shape-memory material be introduced into the carrier layer and/or applied to the carrier layer—for example, to a front side of the carrier layer.

Preferably, the layer structure comprises at least one further layer, in particular an adhesive layer and/or a nonwoven and/or a film, wherein the shape-memory material is introduced into the further layer or into one or more further layers and/or is applied to the further layer or to one or more of the further layers.

It can be provided that a first adhesive layer and a second adhesive layer be arranged on the rear side of the decorative layer. In particular, the first adhesive layer can be arranged on the rear side of the decorative layer. The second adhesive layer can in turn be arranged, in particular in portions, on the rear side of the first adhesive layer. Furthermore, a nonwoven can be arranged on the rear side of the decorative layer by means of the first and second adhesive layers. As an alternative to the nonwoven, other stabilization layers can also be provided.

One embodiment variant of the invention provides that the layer structure have a shape-memory material layer, which is formed by the shape-memory material. The shape-memory material layer can be arranged, for example, on the rear side of the decorative layer.

Preferably, a light function of the shape-memory material is realized by a shape-memory material introduced into or applied on a layer, close to the visible side, of the layer structure, in particular in order to produce the strongest possible optical effect on the visible side of the motor vehicle interior trim part.

For a haptic effect, a shape-memory material introduced into or applied on a layer, close to the visible side, of the layer structure is also advantageous, especially because reversible expansion has limited variants.

A heating function by means of the shape-memory material is also preferably to be realized by a shape-memory material introduced into or applied on a layer close to the visible side, in particular in order to ensure the most effective radiation possible.

The layer close to the visible side can, for example, be the decorative layer and/or an adhesive layer and/or a nonwoven.

It can be provided that the shape-memory material layer form a light mask with a darkening effect, wherein the light mask is at least partially transparent or translucent when the shape-memory material is energized and is opaque or at least partially opaque when the shape-memory material is not energized, or, alternatively, is opaque or at least partially opaque when the shape-memory material is energized and is at least partially transparent or translucent when the shape-memory material is not energized.

The light mask can also be designed dynamically, in particular in such a way that the light mask appears transparent or translucent in portions that change, in particular over time, and appears opaque in the other portions. Preferably, a series connection, in particular a plurality of shape-memory materials, with preferably separate control, is provided for this purpose.

It can be provided that the shape-memory material be or comprise a metallic shape-memory material, in particular a, for example, stamped, sheet metal and/or a wire mat, and/or a metal alloy and/or a granulate and/or component of a granulate and/or a shape-memory polymer and/or a magnetic shape-memory material and/or a piezoelectric shape-memory material and/or an electroactive polymer. The shape-memory material can also be added to a granulate as an additive.

If the shape-memory material is a stamped sheet, one or more portions of the sheet can be activated when energized, so that these portions undergo a change in shape.

According to one embodiment variant of the invention, the motor vehicle interior trim part comprises one or more activation means for controlling the shape-memory material by means of a pulse, wherein the pulse is effected by means of light and/or electromagnetic waves and/or electricity and/or temperature and/or force and/or acoustics and/or sensors.

Preferably, the shape-memory material is provided for realizing a deformation function and/or a light function and/or an acoustic function and/or a haptic effect, in particular by expansion of the shape-memory material, and/or a heating function, in particular by heating during expansion of the shape-memory material after a, preferably electrical, control.

A haptic effect can be provided in particular as a feedback function and/or tactile aid for a user in or on or near switches and/or sensors.

It can be provided that the motor vehicle interior trim part comprise an electrical or electronic control for the shape-memory material.

Preferably, the motor vehicle interior trim part comprises one or more light elements, e.g., LED's, and/or one or more sensor elements, and/or one or more heating elements.

The light element(s) and/or the sensor element(s) can be incorporated into the carrier layer or arranged on the carrier layer, in particular the rear side of the carrier layer.

For example, the light element(s) and/or the sensor element(s) and/or the heating element(s) can be used to activate the shape-memory material and thereby in particular form activation agents.

### BRIEF DESCRIPTION OF THE DRAWINGS

The invention is further described below by means of examples of embodiments and with reference to the drawings. They show in each case in a schematic representation:

FIG. 1 shows a cutout of a motor vehicle interior trim part according to an exemplary embodiment of the present invention.

Corresponding parts and sizes are marked with the same reference signs in the drawings.

The invention is explained in more detail below also with regard to further features and advantages on the basis of the description of an exemplary embodiment and with reference to the accompanying schematic drawing.

### DETAILED DESCRIPTION

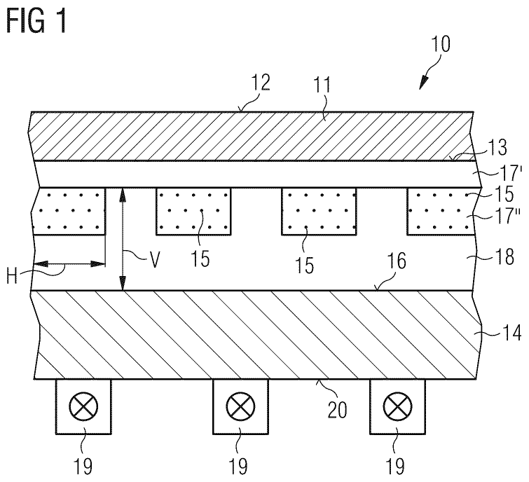

FIG. 1 shows a cutout of a motor vehicle interior trim part 10 according to the invention in a schematic sectional view. The motor vehicle interior trim part 10 according to the invention has a layer structure, wherein the layer structure comprises a decorative layer 11 with a front side 12 designed as the visible side and a rear side 13 opposite the front side 12. The decorative layer 11 is, for example, a wood veneer. Furthermore, the layer structure comprises a carrier layer 14, e.g., made of plastic, arranged on the rear side 13 of the decorative layer 11.

The layer structure further comprises three further layers: a first adhesive layer 17′, a second adhesive layer 17″, and a nonwoven 18. The first adhesive layer 17′ and the second adhesive layer 17″ are arranged on the rear side 13 of the decorative layer 11. The first adhesive layer 17′ is arranged directly on the rear side 13 of the decorative layer 11, whereas the second adhesive layer 17″ is arranged in portions on the rear side of the first adhesive layer 17′. By applying the second adhesive layer 17″ in portions, open spaces are formed in this layer which can form a symbol in a plan view of the visible side of the decorative layer 11. Furthermore, the nonwoven 18 is arranged on the rear side 13 of the decorative layer 11 by means of the first and second adhesive layers 17′, 17″. The decorative layer 11 and the first adhesive layer 17′ are preferably at least translucent. The second adhesive layer 17″ can be opaque. Furthermore, the nonwoven 18 and the carrier layer 14 can be at least translucent.

According to the invention, the motor vehicle interior trim part 10 has a shape-memory material 15 for functional implementation, wherein the shape-memory material 15 is introduced into the second adhesive layer 17″. In addition to the shape-memory material, other materials can also be introduced into the second adhesive layer 17″.

The motor vehicle interior trim part 10 comprises a plurality of light elements 19 designed as LED's. The light elements 19 are arranged on the rear side 20 of the carrier layer 14. The light elements 19 can be used to activate the shape-memory material 15 by means of a pulse, wherein the pulse is provided by means of light and/or electromagnetic waves. The motor vehicle interior trim part 10 may alternatively or additionally comprise an electrical or electronic control (not shown in the FIGURE) for the shape-memory material.

The shape-memory material 15 is provided for realizing a deformation function. When the shape-memory material 15 is activated, it expands the second adhesive layer 17″ both in the horizontal H and the vertical V.

If the decorative layer 11, the first adhesive layer 17′, the nonwoven 18, and the carrier layer 14 are translucent, and the second adhesive layer 17″ is opaque, the symbol formed by the second decorative layer 17″ applied in portions can change when backlit by the light elements 19 if the second adhesive layer 17″ expands due to activation of the shape-memory material 15, in particular because the open areas in the second adhesive layer 17″-through which the light emanating from the light elements 19 shines—are reduced in size. In this way, the size of the symbol highlighted by backlighting can be varied.

### LIST OF REFERENCE SIGNS

10 Motor vehicle interior trim part
11 Decorative layer
12 Front side (decorative layer)
13 Rear side (decorative layer)
14 Carrier layer
15 Shape-memory material
16 Front side (carrier layer)
17′ Adhesive layer
17″ Adhesive layer
18 Nonwoven
19 Light element
20 Rear side (carrier layer)
H Horizontal
V Vertical

1-12. (canceled)

13. Motor vehicle interior trim part,
wherein the motor vehicle interior trim part has a layered structure, wherein the layered structure comprises a decorative layer having a front side designed as a visible side and a rear side opposite the front side, wherein:
the motor vehicle interior trim part has at least one shape-memory material.

14. Motor vehicle interior trim part according to claim 13, wherein:
the shape-memory material is introduced into the decorative layer and/or applied to the decorative layer.

15. Motor vehicle interior trim part according to claim 13, wherein:
the layered structure comprises a carrier layer arranged on the rear side of the decorative layer.

16. Motor vehicle interior trim part according to claim 15, wherein:
the shape-memory material is introduced into the carrier layer and/or applied to the carrier layer.

17. Motor vehicle interior trim part according to claim 13, wherein:
the layer structure comprises at least one further layer, wherein the shape-memory material is introduced into the further layer or into one or more further layers and/or is applied to the further layer or to one or more of the further layers.

18. Motor vehicle interior trim part according to claim 13, wherein:
the layer structure has a shape-memory material layer, wherein the shape-memory material layer is formed by the shape-memory material.

19. Motor vehicle interior trim part according to claim 18, wherein:
the shape-memory material layer forms a light mask with a darkening effect, wherein the light mask is transparent or translucent when the shape-memory material is energized and is opaque or at least partially opaque when the shape-memory material is not energized.

20. Motor vehicle interior trim part according to claim 13, wherein:
the shape-memory material is or comprises a metallic shape-memory material and/or a metal alloy and/or a granulate and/or a component of a granulate and/or a shape-memory polymer and/or a magnetic shape-memory material and/or a piezoelectric shape-memory material and/or an electroactive polymer.

21. Motor vehicle interior trim part according to claim 13, wherein:
the motor vehicle interior trim part comprises one or more activation means for controlling the shape-memory material by means of a pulse, wherein the pulse is effected by means of light and/or electromagnetic waves and/or electricity and/or temperature and/or force and/or acoustics and/or sensors.

22. Motor vehicle interior trim part according to claim 13, wherein:
the shape-memory material is provided for realizing a deformation function and/or a light function and/or an acoustic function and/or a haptic effect and/or a heating function.

23. Motor vehicle interior trim part according to claim 13, wherein:
the motor vehicle interior trim part comprises an electrical or electronic control for the shape-memory material.

24. Motor vehicle interior trim part according to claim 13, wherein:
the motor vehicle interior trim part comprises one or more light elements and/or one or more sensor elements and/or one or more heating elements.
